(19) United States
(12) Patent Application Publication
(10) Pub. No.: US 2025/0316164 A1
(43) Pub. Date: Oct. 9, 2025

(54) ROADWAY INCIDENT SEVERITY ESTIMATION FOR TRAFFIC MANAGEMENT

(71) Applicants: TOYOTA MOTOR ENGINEERING & MANUFACTURING NORTH AMERICA, INC., PLANO, TX (US); MCMASTER UNIVERSITY, HAMILTON (CA)

(72) Inventors: YASHAR ZEIYNALI FARID, Mountain View, CA (US); HAO YANG, Hamilton (CA); SEYHAN UCAR, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP); MCMASTER UNIVERSITY, HAMILTON (CA)

(21) Appl. No.: 18/627,878

(22) Filed: Apr. 5, 2024

(51) Int. Cl. G08G 1/015; G06T 7/73; G06V 20/58; G08G 1/01; G08G 1/017; G08G 1/04

(52) U.S. Cl. CPC G08G 1/015; G06T 7/74; G06V 20/58; G08G 1/0125; G08G 1/0175; G08G 1/04; G06T 2207/30242; G06T 2207/30256; G06V 2201/08

(57) ABSTRACT

Systems and methods are provided for determining a start time and severity value associated with the roadway incident to provide traffic management instructions. The system may, for example, receive sensor data from a vehicle at a location associated with a roadway incident. The system can determine a traffic flow profile for the location, where the traffic flow profile identifies characteristics of the roadway incident that match characteristics of the traffic flow profile. Based on the traffic flow profile, the system may determine a severity value for the roadway incident and calculate a start time of the roadway incident. The start time may correspond with the traffic flow profile for the location in view of the severity value.

### TECHNICAL FIELD

The present disclosure relates generally to providing traffic management in view of a roadway incident, and more particularly, to determining a start time and severity value associated with the roadway incident to provide traffic management instructions based on the timing that a vehicle encounters the roadway incident after the roadway incident occurred.

### DESCRIPTION OF RELATED ART

Roadway incidents and traffic accidents (used interchangeably) can block lanes or roads, which can generate congestion across transportation systems. These incidents can reduce the road capacities and increase congestion levels of the road network. However, different types of road incidents have different impact on road congestion. Minor incidents may block only one lane and can be resolved in several minutes. Moderate incidents may block multiple lanes with an open lane for traffic to pass. Severe incidents can block a road and create massive congestion throughout the road network. Without an accurate estimate of the incident severity, traffic management may be less accurate and it can potentially further increase the congestion levels of the transportation system.

### BRIEF SUMMARY OF THE DISCLOSURE

According to various embodiments of the disclosed technology, systems, methods, and computer readable media are described throughout the disclosure. for example, a system may comprise a processor and memory, where the processor is configured to receive sensor data from a vehicle at a location in a transportation network, the location being associated with a roadway incident at a first time, and determine a traffic flow profile for the location. The traffic flow profile may identify characteristics of the roadway incident that match characteristics of the traffic flow profile at a second time. In some examples, based on the traffic flow profile, the system may determine a severity value for the roadway incident at the first time. The system may also calculate a start time of the roadway incident that is prior to the first time. The start time may correspond with the traffic flow profile for the location in view of the severity value at the first time.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example vehicle architecture for implementing vehicle instructions in accordance with some embodiments of the systems and methods described herein.

FIG. 3 illustrates a roadway incident response system and vehicles, according to some embodiments.

FIG. 4 illustrates a set of vehicles that implement vehicle instructions associated with a roadway incident severity estimation for traffic management in accordance with some embodiments of the systems and methods described herein.

FIG. 5 illustrates a set of vehicles that implement vehicle instructions associated with a roadway incident severity estimation for traffic management in accordance with some embodiments of the systems and methods described herein.

FIG. 6 illustrates a set of vehicles that implement vehicle instructions associated with a roadway incident severity estimation for traffic management in accordance with some embodiments of the systems and methods described herein.

FIG. 7 provides illustrative examples of a minor incident and a severe incident in accordance with some embodiments of the systems and methods described herein.

FIG. 8 illustrates a bell curve corresponding with a traffic flow profile in accordance with some embodiments of the systems and methods described herein.

FIG. 9 illustrates an example process that may be used to implement various features of embodiments described in the present disclosure.

FIG. 10 is an example computing component that may be used to implement various features of embodiments described in the present disclosure.

The figures are not exhaustive and do not limit the present disclosure to the precise form disclosed.

### DETAILED DESCRIPTION

Examples of systems and methods described herein can estimate the severity of a roadway incident or traffic accident (used interchangeably) based on calculating a start time of the roadway incident after it occurred. For example, the system can determine the severity value or severity level (used interchangeably) to enable the system to predict the start time and duration of the roadway incident, which can also help predict future traffic conditions associated with the roadway incident more accurately.

The severity value may be a numerical scale (e.g., 0-100) or a categorical scale (e.g., “minor,” “moderate,” “severe”).

In some examples, the system can receive various sensor data, including image data captured from one or more vehicles in the vicinity of the roadway incident and traffic data to detect and classify the roadway incident. The system can estimate the start time of the roadway incident and the duration of the roadway incident based on the detected traffic conditions in the sensor data. Various characteristics of the roadway incident may be considered when determining the severity of the roadway incident, including the number of blocked lanes associated with the incident, the existence of emergency vehicles or roadway cones, receiving sensor data from vehicles in the incident, like when the airbags were deployed, or other characteristics like speed of the vehicles, traffic flow, and traffic/vehicle density.

In some examples, the system can determine the start time of the roadway incident to help determine how severe the roadway incident is. The system can adjust instructions to vehicles to respond to the roadway incident to help improve the effectiveness of traffic management strategies. For example, affected drivers in connected vehicles are notified of the incident and, if necessary, given navigational assistance (e.g., rerouting). Other actions and estimations of the roadway incident are available to help improve traffic management strategies.

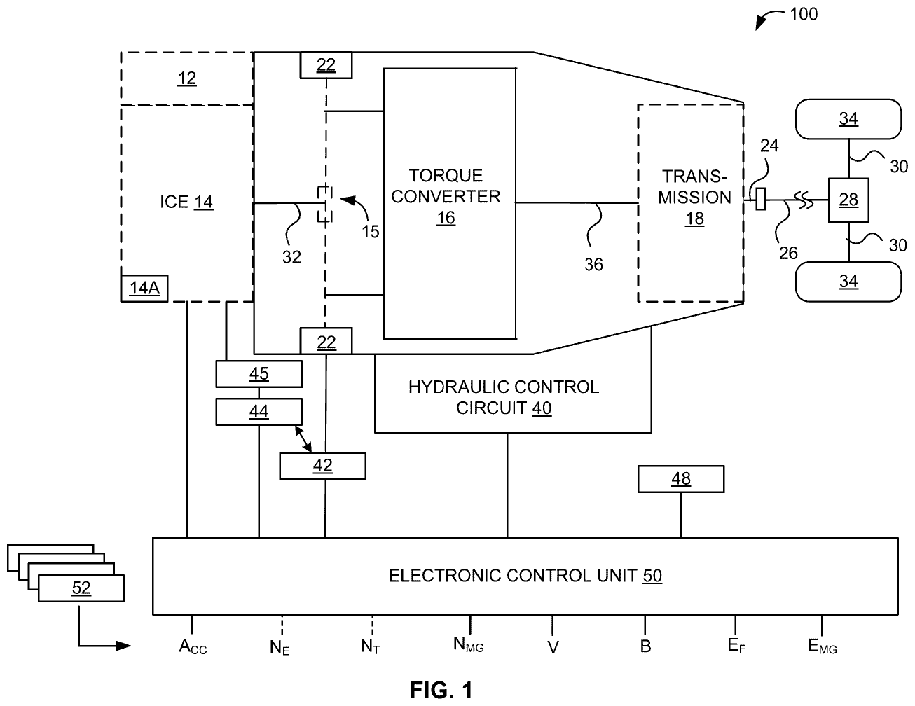

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for programmatically verifying the origin of abnormal driving can be implemented in other types of vehicles including gasoline-or diesel-powered vehicles, fuel-cell vehicles, electric vehicles, or other vehicles. Any of these vehicles may be implemented as a connected or non-connected vehicle.

FIG. 1 illustrates a drive system of vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

Output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage battery charger 45. Battery 44 may also be charged by motor 22 such as, for example, by regenerative braking or by coasting during which time motor 22 operate as generator.

Motor 22 can be powered by battery 44 to generate a motive force to move vehicle 100 and adjust vehicle speed. Motor 22 can also function as a generator to generate electrical power such as, for example, when coasting or braking. Battery 44 may also be used to power other electrical or electronic systems in vehicle 100. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

Electronic control unit 50 (described below) may be included and may control the electric drive components of vehicle 100 as well as other vehicle components. For example, electronic control unit 50 may control inverter 42, adjust driving current supplied to motor 22, and adjust the current received from motor 22 during regenerative coasting and breaking. As a more particular example, output torque of motor 22 can be increased or decreased by electronic control unit 50 through inverter 42.

Torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of vehicle 100. In the illustrated example, crankshaft 32, which is an output member of engine 14, may be selectively coupled to motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated).

When clutch 15 is engaged, power transmission is provided in the power transmission path between crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of clutch 15.

As alluded to above, vehicle 100 may include electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in vehicle 100. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more sensors 52 may include their own processing capability to compute the results for additional information that can be provided to electronic control unit 50. In other embodiments, one or more sensors 52 may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

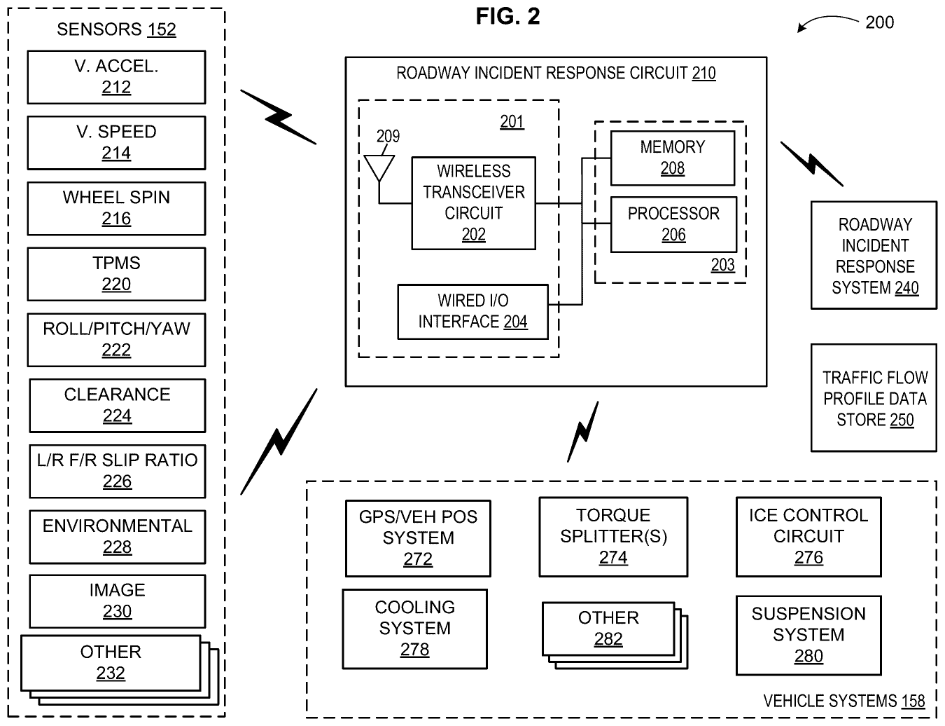

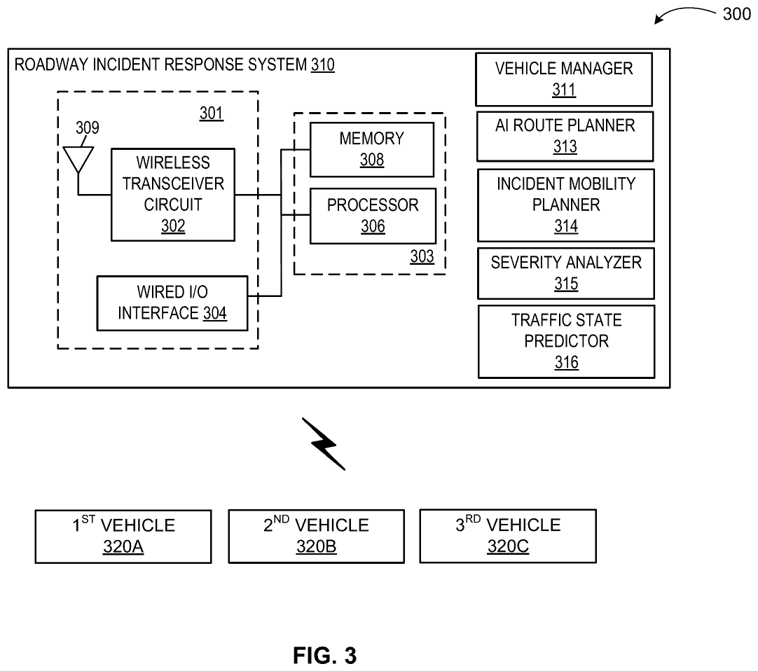

FIG. 2 illustrates an example vehicle architecture for implementing vehicle instructions in accordance with some embodiments of the systems and methods described herein. In example 200, the vehicle includes roadway incident response circuit 210, sensors 152, and vehicle systems 158, in addition to or in replacement of other physical components illustrated in vehicle 100 of FIG. 1. The components of vehicle may comprise roadway incident response circuit 210, sensors 152, and vehicle systems 158, and may electronically communicate with external components of the vehicle, including roadway incident response system 240 and traffic flow profile data store 250, which are further described with FIG. 3.

Sensors 152 and vehicle systems 158 can communicate with roadway incident response circuit 210 via a wired or wireless communication interface. Although sensors 152 and vehicle systems 158 are depicted as communicating with roadway incident response circuit 210, they can also communicate with each other as well as with other vehicle systems. Roadway incident response circuit 210 can be implemented as an ECU or as part of an ECU such as, for example electronic control unit 50 in FIG. 1. In other embodiments, roadway incident response circuit 210 can be implemented independently of the ECU.

Roadway incident response circuit 210, in this example, includes communication circuit 201, decision circuit 203 (including processor 206 and memory 208), and power supply (not shown). Components of roadway incident response circuit 210 are illustrated as communicating with each other via a data bus, although other communication interfaces can be included.

Processor 206 can include one or more GPUs, CPUs, microprocessors, or any other suitable processing system. Processor 206 may include a single core or multicore processors. Memory 208 may include one or more various forms of memory or data storage (e.g., flash, RAM, etc.) that may be used to store the calibration parameters, images (analysis or historic), point parameters, instructions, and variables for processor 206 as well as any other suitable information. Memory 208, can be made up of one or more modules of one or more different types of memory, and may be configured to store data and other information as well as operational instructions that may be used by processor 206 to execute via roadway incident response circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up roadway incident response circuit 210.

Communication circuit 201 may comprise either or both wireless transceiver circuit 202 with antenna 209 and wired I/O interface 204 with an associated hardwired data port (not illustrated). As this example illustrates, communications with roadway incident response circuit 210 can include either or both wired and wireless communications circuits 201. Wireless transceiver circuit 202 can include a transmitter and a receiver (not shown) to allow wireless communications via any of a number of communication protocols such as, for example, Wi-Fi®, Bluetooth®, near field communications (NFC), Zigbee®, and any of a number of other wireless communication protocols whether standardized, proprietary, open, point-to-point, networked or otherwise.

Antenna 209 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by roadway incident response circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet® or any of a number of other wired communication protocols whether standardized, proprietary, open, point-to-point, networked or otherwise.

The power supply (incorporated with any of the features herein) can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 100, with which vehicle 200 is implemented. In the illustrated example, sensors 152 include vehicle acceleration sensors 212, vehicle speed sensors 214, wheelspin sensors 216 (e.g., one for each wheel), tire pressure monitoring system (TPMS) 220, accelerometers such as 3-axis accelerometer 222 to detect roll, pitch and yaw of the vehicle, vehicle clearance sensors 224, left-right and front-rear slip ratio sensors 226, environmental sensors 228 (e.g., to detect salinity or other environmental conditions), and image sensors 230 (e.g., to capture images in the transportation network internal/external to the vehicle). Additional sensors 232 can also be included as may be appropriate for a given implementation of vehicle 200.

In some examples, sensors 152 may also include one or more sensors that are operable to measure a roadway environment outside of vehicle 200. For example, sensors 152 may include one or more sensors that record one or more physical characteristics of the roadway environment that is proximate to vehicle 200.

In some examples, sensors 152 may also include one or more sensors that record an environment internal to a cabin of vehicle 200. For example, sensors 152 includes onboard sensors which monitor the environment of vehicle 200 whether internally or externally. In a further example, sensors 152 includes cameras, LIDAR, radars, infrared sensors, and sensors that observe the behavior of the driver such as internal cameras, biometric sensors, etc. In some examples, sensors 152 may include one or more of the following vehicle sensors: a camera; a LIDAR sensor; a radar sensor; a laser altimeter; an infrared detector; a motion detector; a thermostat; and a sound detector. Sensors 152 may also include one or more of the following sensors: a carbon monoxide sensor; a carbon dioxide sensor; an oxygen sensor; a mass air flow sensor; and an engine coolant temperature sensor. Sensors 152 may also include one or more of the following sensors: a throttle position sensor; a crank shaft position sensor; an automobile engine sensor; a valve timer; an air-fuel ratio meter; and a blind spot meter. Sensors 152 may also include one or more of the following sensors: a curb feeler; a defect detector; a Hall effect sensor, a manifold absolute pressure sensor; a parking sensor; a radar gun; a speedometer; and a speed sensor. Sensors 152 may also include one or more of the following sensors: a tire-pressure monitoring sensor; a torque sensor; a transmission fluid temperature sensor; and a turbine speed sensor (TSS); a variable reluctance sensor; and a vehicle speed sensor (VSS). Sensors 152 may also include one or more of the following sensors: a water sensor; a wheel speed sensor; and any other type of automotive sensor.

Sensors 152 may generate sensor data. For example, the sensor data may comprise digital data describing one or more sensor measurements of sensors 152. For example, the sensor data may include vehicle data describing vehicle 200 (e.g., GPS location data, speed data, heading data, etc.), driver, and other sensor data describing a roadway environment (e.g., camera data depicting a roadway or a vehicle's proximity to other vehicles, etc.).

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

In some examples, roadway incident response circuit 210 of the vehicle can receive information from vehicle sensors 152 and transmit the information to roadway incident response system 240. Communication circuit 201 can be used to transmit and receive information between roadway incident response circuit 210 and sensors 152, and roadway incident response circuit 210 and vehicle systems 158. Also, sensors 152 may communicate with vehicle systems 158 directly or indirectly (e.g., via communication circuit 201 or otherwise).

In some examples, roadway incident response system 240 can receive information from roadway incident response circuit 210 and traffic flow profile data store 250. Similar features of roadway incident response circuit 210 may be implemented with roadway incident response system 240 and traffic flow profile data store 250 (e.g., processor 206, memory 208, etc.).

Roadway incident response system 240 may include software that is operable to assess data associated with the roadway incident and predicted duration of the roadway incident based on the severity and predicted start time of the roadway incident. In some embodiments, roadway incident response system 240 may be implemented using hardware including a field-programmable gate array (“FPGA”) or an application-specific integrated circuit (“ASIC”). In some other embodiments, roadway incident response system 240 may be implemented using a combination of hardware and software. Roadway incident response system 240 may be stored in a combination of the devices (e.g., servers or other devices), or in one of the devices. Additional detail on roadway incident response system 240 is provided with FIG. 3.

Traffic flow profile data store 250 may comprise data characteristics of the traffic flow profile. The characteristics of the traffic flow profile may comprise a number of blocked lanes associated with the incident, an existence of emergency vehicles or roadway cones, sensor data from vehicles in the incident (e.g., airbags were deployed), or other characteristics like speed of the vehicles, traffic flow, and traffic/vehicle density.

In some examples, the characteristics of the traffic flow profile may comprise characteristics of the vehicle(s) involved in the roadway incident. The characteristics may include the type of vehicle such as motorcycle, SUV, semi-truck, or other features of the vehicle that can affect the speed of moving the vehicle out of the roadway to regain movement of the other vehicles on the roadway in response to the roadway incident. In some examples, the characteristics of the vehicle may be collected using sensors described throughout the disclosure, including sensors 52 in FIG. 1 or sensors 152 in FIG. 2 which include vehicle sensors: a camera; a LIDAR sensor; a radar sensor; a laser altimeter; an infrared detector; a motion detector; a thermostat; a sound detector; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; and a speed sensor.

In some examples, the characteristics of the traffic flow profile may be based on machine learning (ML), artificial intelligence (AI), or a time series where time-ordered events are selected/applied one by one. For example, the traffic flow profile may correspond to characteristics of the vehicles that are present around the roadway incident, the emergency vehicles that should respond to the roadway incident, the number of lanes that are impacted, and other factors. In some examples, an administrative user can provide human assistance to select the traffic flow profile. The user can access the system to select the traffic flow profile or issue a remote command to initiate selection of the traffic flow profile.

FIG. 3 illustrates a roadway incident response system and vehicles, according to some embodiments. In example 300, roadway incident response system 310 may communicate with vehicles 320 via a network, illustrated as first vehicle 320A, second vehicle 320B, and third vehicle 320C. In some examples, vehicles 320 may be autonomous vehicles (no passenger and/or driver) or non-autonomous vehicles. Roadway incident response system 310 receive sensor data from vehicle 320 that is in a location associated with a roadway incident and use the information to calculate a start time for the roadway incident.

The network (not shown) may be a wired or wireless network, including a local area network (LAN), a wide area network (WAN) (e.g., the Internet), or other interconnected data paths across which multiple devices and/or entities may communicate. In some embodiments, the network may include a peer-to-peer network. The network may be coupled to or may include portions of a telecommunications network for sending data in a variety of different communication protocols. In some embodiments, the network includes Bluetooth® communication networks or a cellular communications network for sending and receiving data including via short messaging service (SMS) and multimedia messaging service (MMS). In some embodiments, the network includes networks for hypertext transfer protocol (HTTP), direct data connection, wireless application protocol (WAP), e-mail, DSRC, full-duplex wireless communication and mmWave. In some embodiments, the network includes networks for WiFi (infrastructure mode), WiFi (ad-hoc mode), visible light communication, TV white space communication and satellite communication. The network may also include a mobile data network that may include 3G, 4G, LTE, LTE-V2X, LTE-D2D, VOLTE, 5G-V2X or any other mobile data network. The network may also include any combination of mobile data networks. The network may include one or more IEEE 802.11 wireless networks.

Roadway incident response system 310 may comprise various components to control or monitor various aspects of the roadway incident. For example, roadway incident response system 310 may comprise vehicle manager 311, AI route planner 313, incident mobility planner 314, severity analyzer 315, and traffic state predictor 316. Moreover, roadway incident response system 310 may further comprise a communication circuit 301 (similar to communication circuit 201), decision circuit 303 (including processor 306 and memory 308) (similar to decision circuit 203 including processor 206 and memory 208), and power supply (not shown). Antenna 309 (similar to antenna 209) is coupled to wireless transceiver circuit 302 (similar to circuit 202) and is used by wireless transceiver circuit 302 to transmit radio signals wirelessly to wireless equipment with which it is connected and to receive radio signals as well. Wired I/O interface 304 (similar to interface 204) can include a transmitter and a receiver (not shown) for hardwired communications with other devices.

Vehicle manager 311 may include code and routines for performing coordination between vehicles 320 via V2X communications. The term “V2X” may correspond with “vehicle-to-everything” technology, which is implemented by sensors, cameras, and wireless connectivity that allow vehicles to share real-time information with vehicle operators, other vehicles, and roadway infrastructure (e.g., traffic lights and road signs). For example, vehicle manager 311 may manage (e.g., establish and maintain) inter-vehicular wireless links and control executions of collaborative operations among vehicles 320.

AI route planner 313 may be operable to plan routes for the connected entities based on the hierarchical roadway incident characteristics or other data associated with the roadway incident. In some embodiments, AI route planner 313 may assist roadway incident response circuit 210 illustrated in FIG. 2 to plan routes for the entities that may be affected by the roadway incident.

Incident mobility planner 314 may be operable to monitor information of roadway incident at the location in the transportation network. This information may include, for example, location information, description information, and any other roadway characteristics related to the roadway incident. Incident mobility planner 314 generates a corresponding operation strategy to manage the affected vehicles of the roadway incident based on a corresponding severity value. Incident mobility planner 314 instructs the vehicles to execute the corresponding operation strategy. As a result, incident mobility planner 314 generates a set of operation strategies to reduce the impact of the roadway incident.

The severity value may be a numerical scale (e.g., 0-100) or a categorical scale (e.g., “minor,” “moderate,” “severe”). The severity value be determined by comparing the characteristics of the roadway incident (e.g., number of blocked lanes associated with the incident, the existence of emergency vehicles or roadway cones, receiving sensor data from vehicles in the incident, like when the airbags were deployed, or other characteristics like speed of the vehicles, traffic flow, and traffic/vehicle density) with the characteristics of the traffic flow profile. This might involve comparing measured operations of the vehicle against a checklist or set of benchmarks identified in the instruction. When the characteristics of the roadway incident are within a threshold value of the characteristics of the profile (e.g., 90%), the system may determine the severity value of the roadway incident.

In some examples, the severity value may be weighted. The weight of the severity value may be adjusted based on one or more geographic locations (e.g., a location that is difficult to get to, a two-lane road where all lanes are blocked and the area is inaccessible to emergency vehicles, etc.

For example, with respect to vehicle 320 which is affected by the roadway incident, incident mobility planner 314 identifies that vehicle 320 is present within a threshold value of the location associated with a roadway incident. Strategy generator 311 generates an operation strategy for vehicle 320 based on the severity value determined at the first time. Incident mobility planner 314 sends the operation strategy to vehicle 320. After receiving the strategy data, roadway incident response circuit 210 (of the vehicle illustrated in FIG. 2) may implement the operation strategy during operation of the vehicle. Roadway incident response circuit 210 may follow the operation strategy so that vehicle 320 operates in accordance with the operation strategy to mitigate an effect of the roadway incident. For example, when the operation strategy instructs vehicle 320 to change a lane immediately, roadway incident response circuit 210 may modify the operation of an ADAS system of the vehicle so that the ADAS system controls vehicle to change its lane immediately.

Severity analyzer 315 may be operable to determine a severity value of the roadway incident. For example, each traffic flow profile stored in in the traffic flow profile data store may be associated with particular severity values. For example, more roadway cones or more emergency vehicles may correlate to a higher severity value of the roadway incident. Severity analyzer 315 may correlate the roadway characteristics present at the roadway incident to the characteristics of the traffic flow profile stored in traffic flow profile data store.

In some examples, the characteristics of the roadway incident may be provided as input to a trained machine learning model at roadway incident response system 240. The machine learning model may be trained to associate the characteristics detected with the current roadway incident to characteristics associated with a traffic flow profile. The trained machine learning model may be a supervised machine learning model that classifies the roadway incident as a traffic flow profile with a severity value based on the characteristics.

Severity analyzer 315 may also be operable to calculate the start time of the roadway incident in view of the severity value. For example, the traffic flow profile may associate roadway characteristics of the location with a minor roadway incident that is 50% complete (e.g., based on sensor data from first vehicle 320A). The start time is determined from the predicted duration of the type of roadway incident minus the current time. That is, start time can be computed based on an existing incident queue length, traffic flow rates, and fundamental traffic flow diagram. A propagation speed of the back of queue cab be estimated based on the traffic flow rate and the fundamental traffic diagram. Based on the length of the queue, the incident passed time (e.g., passed time=queue length/propagation speed) can also be estimated, where the start time could be calculated by subtracting passed time from the current time.

In some examples, the start time and traffic flow profile may be used to calculate the end time of the roadway incident. For example, the traffic flow profile may provide a predicted duration of the roadway incident based on similar, historical roadway incidents with similar characteristics. Once the start time is determined, severity analyzer 315 may apply the start time to the predicted duration of the roadway incident to determine the end time of the roadway incident, based on similar historical incidents.

Characteristics of the roadway incident may adjust the end time of the roadway incident. As an illustrative example, an emergency vehicle may be leaving the roadway incident, as detected in sensor data by the vehicles. The time point identified in the traffic flow profile of historical roadway incidents may identify the same characteristic as occurring when the roadway incident is 75% complete. As such, severity analyzer 315 may adjust the end time or duration of the current roadway incident based on similar characteristics occurring as in the profile.

Traffic state predictor 316 may be operable to predict a future traffic situation based on the estimated incident severity (e.g., by way of severity analyzer 315) and other traffic conditions, such as traffic flow rates (e.g., by way of traffic flow profile data store 250). In this way, applications such as AI route planner 313 can leverage the predicted future traffic situations to better route drivers.

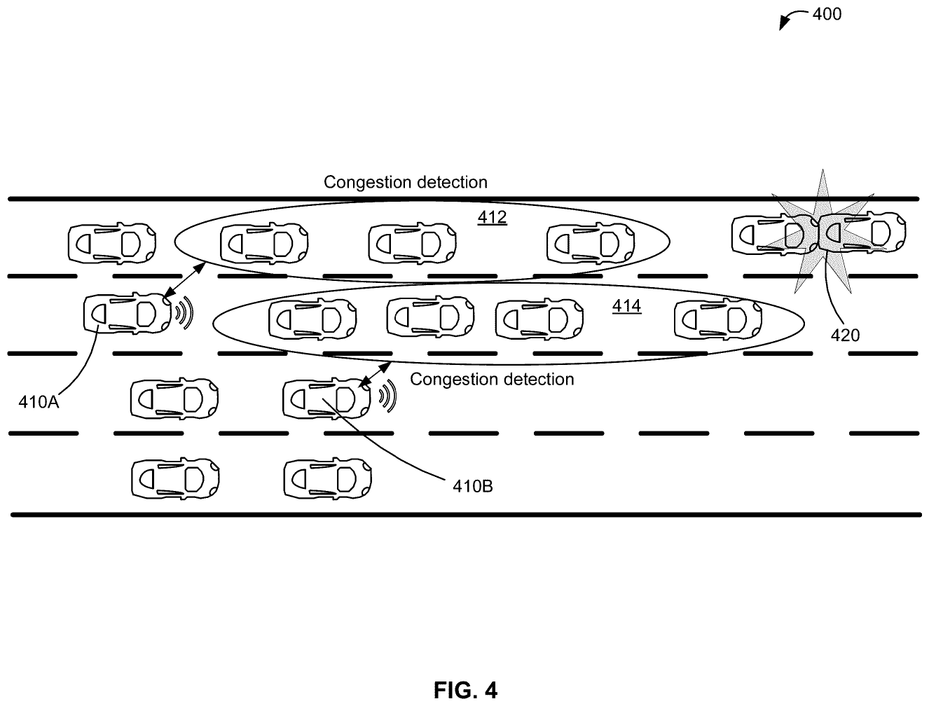

FIG. 4 is a process for providing traffic management according to some embodiments. In example 400, roadway incident response system 310 illustrated in FIG. 3 may perform a series of operations and transmit instructions to the vehicle illustrated in FIG. 1 and FIG. 2.

In this example, vehicles 410, illustrated as first vehicle 410A and second vehicle 410B, may generate sensor data at a location in a transportation network. The location of vehicles 410 may be associated with roadway incident 420 at the same time (e.g., a first time). In some examples, vehicles 410 may be located within a proximate distance of each other to share the same location on the same roadway.

As illustrated, the location of the roadway incident may include two lanes of vehicles 412, 414 that are traveling less than a threshold speed that is detected by first vehicle 410A, and two different lanes of vehicles that are traveling at or greater than the threshold speed that is detected by second vehicle 410B. Each of the sensor data detected by vehicles 410 may be transmitted to roadway incident response system 310. Roadway incident response system 310 may analyze the sensor data to determine that first vehicle 410A and second vehicle 410B are located in the same location and detect the same roadway incident (e.g., locations are within a proximate distance of each other based on location sensor data, both vehicles are facing the same orientation based on orientation sensor data, etc.). It should be understood that distances deemed to be proximate may vary depending on factors such type of roadway, area of operation, etc. Roadway incident response system 310 may use the sensor data to determine a traffic flow profile for the location where the characteristics of the roadway incident that match characteristics of the traffic flow profile stored in a traffic flow profile data store.

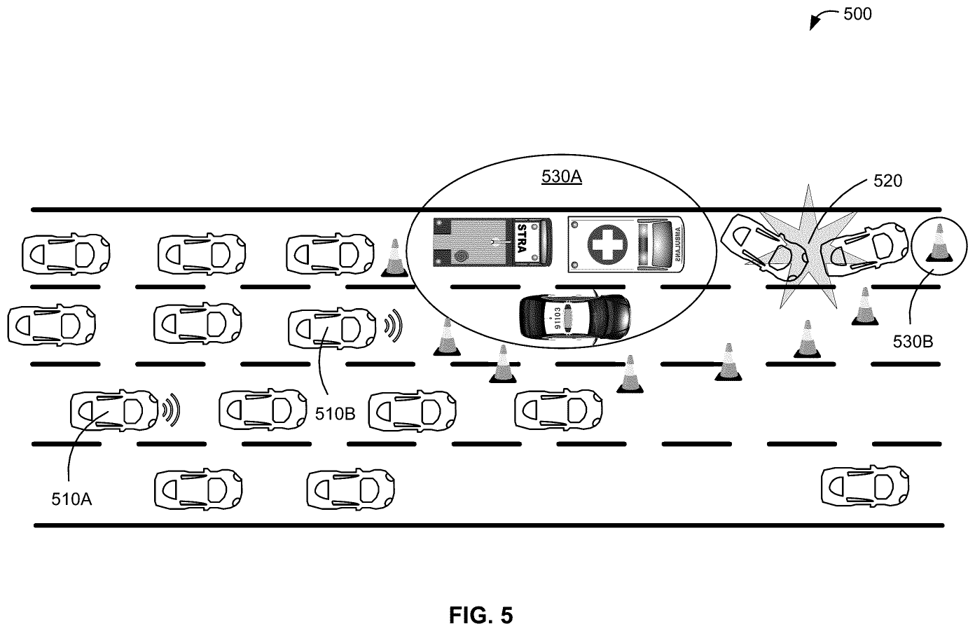

FIG. 5 illustrates a set of vehicles that implement vehicle instructions associated with a roadway incident severity estimation for traffic management in accordance with some embodiments of the systems and methods described herein. In example 500, roadway incident response system 310 illustrated in FIG. 3 may perform a series of operations and transmit instructions to the vehicle illustrated in FIG. 1 and FIG. 2.

In this example, vehicles 510, illustrated as first vehicle 510A and second vehicle 510B, may generate sensor data at a location in a transportation network. The location of vehicles 510 may be associated with roadway incident 520 at the same time (e.g., a first time). In some examples, vehicles 510 may be located within a proximate distance of each other to share the same location on the same roadway.

Roadway incident 520 may also be associated with various characteristics 530 that are considered when determining the severity of the roadway incident, including emergency vehicles 530A and roadway cones 530B. The existence of characteristics may increase the severity value of roadway incident 520 and also increase the start time of roadway incident 520 (e.g., to account for emergency vehicles 530A to be notified of the roadway incident, to travel to the roadway incident, to set up roadway cones 530B around the roadway incident, etc.).

As illustrated, the location of the roadway incident may include two lanes of vehicles that are traveling less than a threshold speed (e.g., blocked by roadway cones 530B) that is detected by first vehicle 510A, and two different lanes of vehicles that are traveling at or greater than the threshold speed (e.g., not blocked by roadway cones 530B) that is detected by second vehicle 510B. Each of the sensor data detected by vehicles 510 may be transmitted to roadway incident response system 310. Roadway incident response system 310 may analyze the sensor data to determine that first vehicle 510A and second vehicle 510B are located in the same location and detect the same roadway incident (e.g., locations are within a proximate distance of each other based on location sensor data, both vehicles are facing the same orientation based on orientation sensor data, etc.). Roadway incident response system 310 may use the sensor data to determine a traffic flow profile for the location where the characteristics of the roadway incident that match characteristics of the traffic flow profile stored in a traffic flow profile data store.

Roadway incident response system 310 may also determine the severity value for the roadway incident based on the traffic flow profile. In particular, roadway incident response system 310 can estimate an upstream flow rate (i.e., inflow entering the incident) and a downstream flow rate (i.e., outflow exiting the incident area). Based on these flow rates, various estimates can be determined. For example, the number of lanes that are blocked can be estimated. Also, based on the speeds of the vehicles the severity of an incident can be estimated, e.g., if vehicles are traveling too slowly in the vicinity of an incident, the slow speed may be an indication that the incident is severe.

Roadway incident response system 310 may also determine the start time of the roadway incident corresponding with the traffic flow profile and in view of the severity value. As described herein, start time can be computed based on an existing incident queue length, traffic flow rates, and fundamental traffic flow diagram. A propagation speed of the back of queue cab be estimated based on the traffic flow rate and the fundamental traffic diagram. Based on the length of the queue, the incident passed time (passed time=queue length/propagation speed) can also be estimated, where the start time could be calculated by subtracting passed time from the current time.

Once the traffic flow profile, severity value, and start time for the roadway incident are determined, roadway incident response system 310 may transmit instructions to vehicles 510, as available, to help guide vehicles 510 accordingly around the roadway incident 520. In some examples, the instructions may be provided to multiple vehicles 510 on the roadway. The instructions may instruct one vehicle at a time to move past the roadway incident or instruct vehicles to take alternative routes to avoid the roadway altogether.

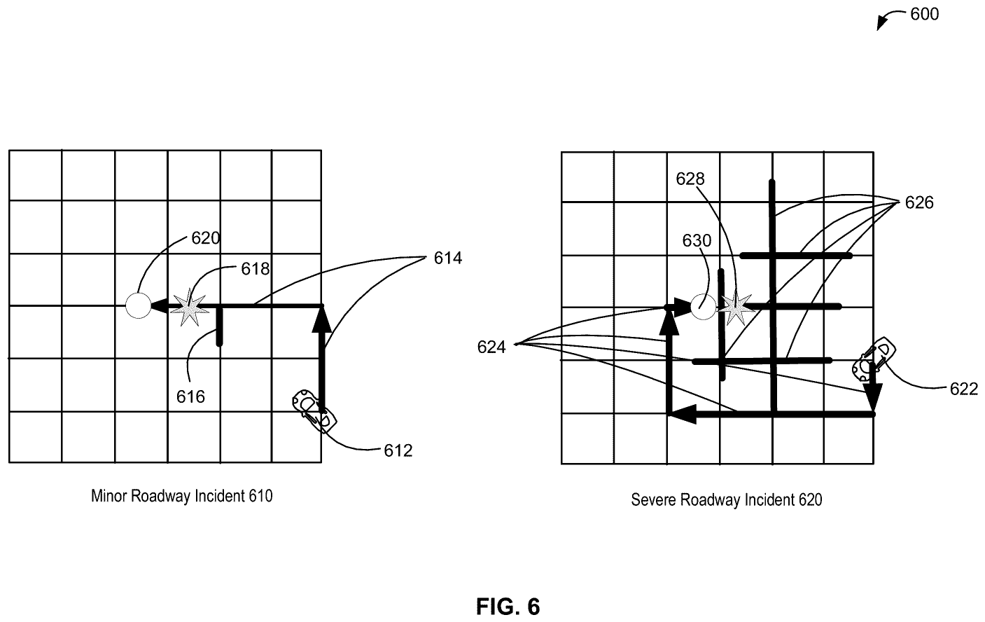

FIG. 6 illustrates a set of vehicles that implement vehicle instructions associated with a roadway incident severity estimation for traffic management in accordance with some embodiments of the systems and methods described herein. In example 600, minor roadway incident 610 and severe roadway incident 620 are illustrated. In minor roadway incident 610, there may be little to no impact (detour 616) on the roadway congestion. The minor roadway incident may be cleared in advance of a threshold amount of time (e.g., 30 minutes). By the time vehicle 612 traverses path 614 and reaches point 620, incident 618 has already been cleared. In severe roadway incident 620, there may be a severe impact on the roadway congestion. The roadway incident may cause other vehicles to detour from the original, shortest route (624) to other routes (626). The roadway incident 628 may not be cleared in advance of the threshold amount of time (e.g., 30 minutes), by the time vehicle 622 reaches point 630.

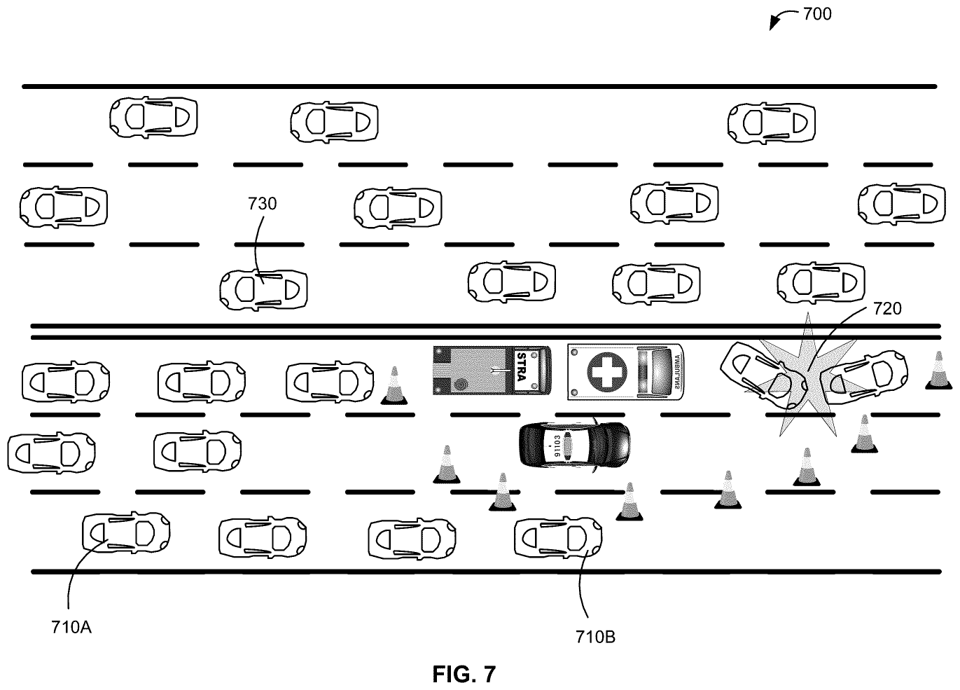

FIG. 7 provides illustrative examples of a minor incident and a severe incident in accordance with some embodiments of the systems and methods described herein. In example 700, a set of vehicles 710 (individually, 710A, 710B, 710C) may be affected by the roadway incident 720 as being in the location/vicinity of the roadway incident and other vehicles 730 may be rubbernecking, or slowing down on a different roadway to view roadway incident 720.

In some examples, rubbernecking may be associated with a characteristic of the roadway incident. Existence of rubbernecking may increase the severity value of the roadway incident, yet may not extend the start time or duration of the roadway incident. Rather, the existence of rubbernecking may cause a second roadway incident on a different roadway that is associated with the first roadway.

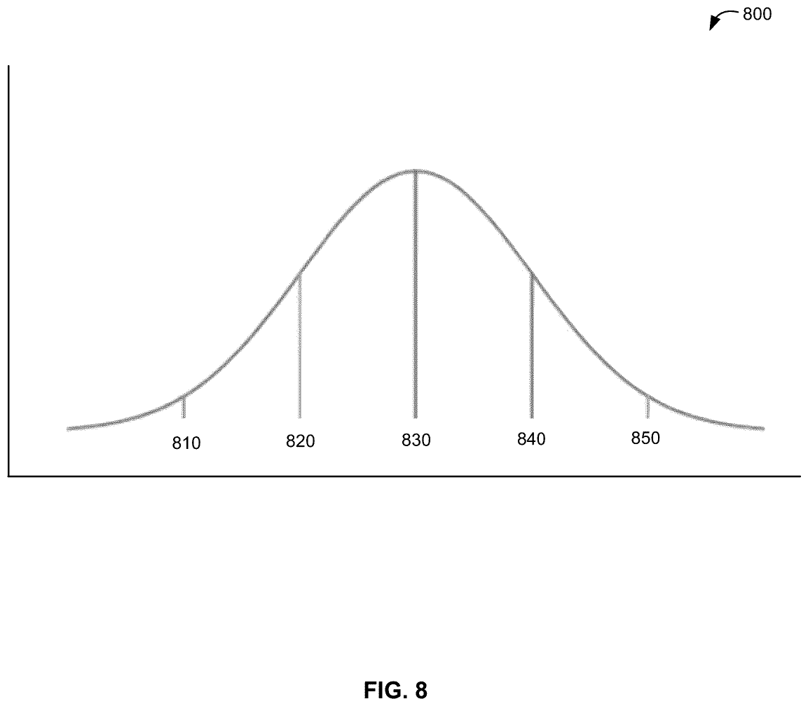

FIG. 8 illustrates a bell curve corresponding with a traffic flow profile in accordance with some embodiments of the systems and methods described herein. In example 800, the bell curve may identify roadway congestion across the duration of the roadway incident, which starts at a particular start time 810 and ends a particular end time 850. Start time 810 may be determined based on a bell curve that depicts the timing duration of the roadway incident, as described throughout the disclosure.

Characteristics of the roadway incident may adjust end time 850 of the roadway incident. As an illustrative example, two lanes of the roadway may be blocked and detected by vehicle sensor data at a first time 820, an emergency vehicle may arrive at a second time 830, and the emergency vehicle may leave the location of the roadway incident at a third time 840. Other characteristics may be plotted on the bell curve without diverting from the essence of the disclosure. The system may adjust future timings along the bell curve, including the end time 850 or duration of the current roadway incident, based on similar characteristics occurring as in the traffic flow profile.

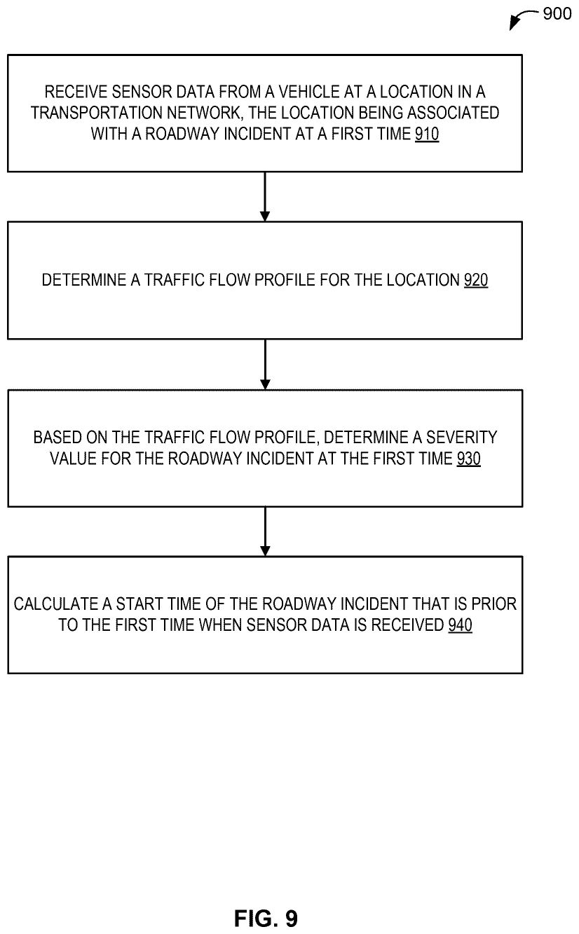

FIG. 9 illustrates an example process that may be used to implement various features of embodiments described in the present disclosure. In example 900, vehicle with roadway incident response circuit 210 or roadway incident response system 240 illustrated in FIG. 2 or 3 may perform various functions described herein. In some examples, the system may perform a series of operations and transmit instructions to vehicles described herein.

At block 910, the process may receive sensor data from a vehicle at a location. The location may be included as a location in a transportation network. In some examples, the location may be associated with a roadway incident at a first time. The sensor data may comprise, for example, image data captured from one or more vehicles in the vicinity of the roadway incident and traffic data to detect and classify the roadway incident. In some examples, roadway incident response circuit of the vehicle can receive information from the vehicle sensors and transmit the information to the roadway incident response system.

At block 920, the process may determine a traffic flow profile for the location. The traffic flow profile may identify characteristics of the roadway incident that match characteristics of the traffic flow profile at a second time.

The characteristics of the traffic flow profile may comprise a number of values or features of the traffic incident. For example, the traffic flow profile may define a number of blocked lanes associated with the incident, an existence of emergency vehicles or roadway cones, sensor data from vehicles in the incident (e.g., airbags were deployed), or other characteristics like speed of the vehicles, traffic flow, and traffic/vehicle density. In some examples, the characteristics of the traffic flow profile may comprise characteristics of the vehicle(s) involved in the roadway incident. The characteristics may include the type of vehicle such as motorcycle, SUV, semi-truck, or other features of the vehicle that can affect the speed of moving the vehicle out of the roadway to regain movement of the other vehicles on the roadway in response to the roadway incident. In some examples, the characteristics of the vehicle may be collected using sensors described throughout the disclosure. In some examples, the characteristics of the traffic flow profile may be based on machine learning (ML), artificial intelligence (AI), or a time series where time-ordered events are selected/applied one by one. For example, the traffic flow profile may correspond to characteristics of the vehicles that are present around the roadway incident, the emergency vehicles that should respond to the roadway incident, the number of lanes that are impacted, and other factors. In some examples, an administrative user can provide human assistance to select the traffic flow profile. The user can access the system to select the traffic flow profile or issue a remote command to initiate selection of the traffic flow profile.

At block 930, the process may determine a severity value for the roadway incident at the first time. The determination of the severity value may be based on the traffic flow profile. The severity value may be a numerical scale (e.g., 0-100) or a categorical scale (e.g., “minor,” “moderate,” “severe”). Various characteristics of the roadway incident may be considered when determining the severity of the roadway incident, including the number of blocked lanes associated with the incident, the existence of emergency vehicles or roadway cones, receiving sensor data from vehicles in the incident, like when the airbags were deployed, or other characteristics like speed of the vehicles, traffic flow, and traffic/vehicle density. The values associated with the traffic incident at the first time may be compared to the threshold values defined in the traffic flow profile. When the values associated with the incident match the profile, the profile may be assigned to the incident at the first time.

At block 940, the process may calculate a start time of the roadway incident that is prior to the first time. In some examples, the start time may correspond with the traffic flow profile for the location in view of the severity value at the first time. In some examples, the process can determine the start time of the roadway incident to help determine how severe the roadway incident is. The process can estimate the start time of the roadway incident and the duration of the roadway incident based on the detected traffic conditions in the sensor data.

The instructions to vehicles can be adjusted to respond to the roadway incident to help improve the effectiveness of traffic management strategies. For example, affected drivers in connected vehicles are notified of the incident and, if necessary, given navigational assistance (e.g., rerouting). Other actions and estimations of the roadway incident are available to help improve traffic management strategies.

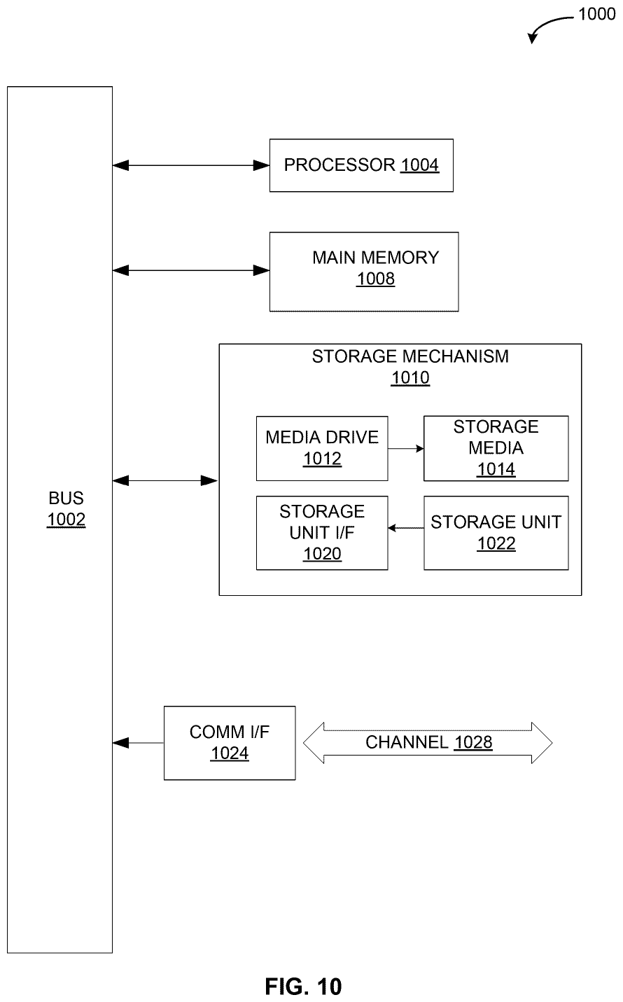

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. This can include a processor, and/or any one or more of the components making up vehicle 100 of FIG. 1, vehicle 200 of FIG. 2, or vehicle 350 or anomaly managing system 300 of FIG. 3. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

Computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a memory; and
a processor that is configured to execute machine readable instructions stored in the memory to cause the processor to:
receive sensor data from a vehicle at a location in a transportation network, the location being associated with a roadway incident at a first time;
determine a traffic flow profile for the location, the traffic flow profile identifying characteristics of the roadway incident that match characteristics of the traffic flow profile at a second time;
based on the traffic flow profile, determine a severity value for the roadway incident at the first time; and
calculate a start time of the roadway incident that is prior to the first time, the start time corresponding with the traffic flow profile for the location in view of the severity value at the first time.

2. The system of claim 1, wherein the characteristics of the traffic flow profile comprise speed, density, and traffic flow.

3. The system of claim 1, wherein the sensor data comprises image data, and wherein the processor is further caused to:
identifying an emergency vehicle leaving the location of the roadway incident in the image data; and
determining an end time of the roadway incident that is associated with the start time, the severity value, the traffic flow profile, and the emergency vehicle leaving the location of the roadway incident.

4. The system of claim 1, wherein the sensor data comprises image data, and wherein the processor is further caused to:
identifying a count of emergency vehicles that exceed a threshold value at the location of the roadway incident in the image data; and
determining an end time of the roadway incident that is associated with the start time, the severity value, the traffic flow profile, and the count of emergency vehicles.

5. The system of claim 1, wherein the sensor data comprises image data, and wherein the processor is further caused to:
identifying emergency cones at the location of the roadway incident in the image data; and
determining an end time of the roadway incident that is associated with the start time, the severity value, the traffic flow profile, and the emergency cones at the location of the roadway incident.

6. The system of claim 1, wherein the traffic flow profile comprises a standard duration to cure other roadway incidents that are within a threshold similarity of the roadway incident.

7. The system of claim 1, wherein the processor is further caused to:
provide instructions to a group of vehicles that have passed the location of the roadway incident to provide updated navigation instructions.

8. The system of claim 1, wherein the traffic flow profile is a bell curve along a timeline, wherein the start time of the bell curve and an end time of the bell curve correspond with speeds greater than a threshold value for the location.

9. The system of claim 1, wherein the processor is further caused to:
receive information associated with a roadway incident; and
assess the information associated with the roadway incident.

10. A method comprising:
receiving sensor data from a vehicle at a location in a transportation network, the location being associated with a roadway incident at a first time;
determining a traffic flow profile for the location, the traffic flow profile identifying characteristics of the roadway incident that match characteristics of the traffic flow profile at a second time;
based on the traffic flow profile, determining a severity value for the roadway incident at the first time; and
calculating a start time of the roadway incident that is prior to the first time, the start time corresponding with the traffic flow profile for the location in view of the severity value at the first time.

11. The method of claim 10, wherein the characteristics of the traffic flow profile comprise speed, density, and traffic flow.

12. The method of claim 10, wherein the sensor data comprises image data, and the method further comprises:
identifying an emergency vehicle leaving the location of the roadway incident in the image data; and
determining an end time of the roadway incident that is associated with the start time, the severity value, the traffic flow profile, and the emergency vehicle leaving the location of the roadway incident.

13. The method of claim 10, wherein the sensor data comprises image data, and the method further comprises:
identifying a count of emergency vehicles that exceed a threshold value at the location of the roadway incident in the image data; and
determining an end time of the roadway incident that is associated with the start time, the severity value, the traffic flow profile, and the count of emergency vehicles.

14. The method of claim 10, wherein the sensor data comprises image data, and the method further comprises:
identifying emergency cones at the location of the roadway incident in the image data; and
determining an end time of the roadway incident that is associated with the start time, the severity value, the traffic flow profile, and the emergency cones at the location of the roadway incident.

15. The method of claim 10, wherein the traffic flow profile comprises a standard duration to cure other roadway incidents that are within a threshold similarity of the roadway incident.

16. The method of claim 10 further comprising:
providing instructions to a group of vehicles that have passed the location of the roadway incident to provide updated navigation instructions.

17. The method of claim 10, wherein the traffic flow profile is a bell curve along a timeline, wherein the start time of the bell curve and an end time of the bell curve correspond with speeds greater than a threshold value for the location.

18. The method of claim 10 further comprising:
receiving information associated with a roadway incident; and
assessing the information associated with the roadway incident.

19. A method comprising:
receiving information associated with a roadway incident; and
assessing the information associated with the roadway incident by:
determining a traffic flow profile for the information associated with the roadway incident,
based on the traffic flow profile, determining a severity value for the roadway incident, and
calculate a start time of the roadway incident, the start time corresponding with the traffic flow profile in view of the severity value.

20. The method of claim 19, wherein the assessing of the information associated with the roadway incident further comprises:
identifying a count of emergency vehicles, and
determining an end time of the roadway incident that is associated with the start time and the count of emergency vehicles.
